(19) United States
(12) Patent Application Publication
(10) Pub. No.: US 2016/0337287 A1
(43) Pub. Date: Nov. 17, 2016

(54) ELECTRONIC MAIL PROCESSING

(71) Applicant: Alibaba Group Holding Limited, Grand Cayman (KY)

(72) Inventors: Guangqian Dong, Hangzhou (CN); Hang Chen, Hangzhou (CN); Zhenhao WU, Hangzhou (CN)

(21) Appl. No.: 15/152,390

(22) Filed: May 11, 2016

(30) Foreign Application Priority Data
May 14, 2015 (CN) 201510245800.4

(51) Int. Cl. H04L 12/58; G06Q 10/10

(52) U.S. Cl. CPC H04L 51/12; G06Q 10/107; H04L 51/32; H04L 51/22; G06Q 50/01

(57) ABSTRACT

Example embodiments of the present disclosure disclose an electronic mail processing method, a client terminal, and a server. The method includes: acquiring an electronic mail to obtain an identity identifier that identifies a mail sender; acquiring relationship data corresponding to the identity information, wherein the relationship data represents a social relationship between mail communication participants; and when the social relationship represented by the relationship data satisfies a predetermined screening rule, presenting the electronic mail on the basis of a predetermined presentation rule.

### CROSS REFERENCE TO RELATED APPLICATION

The present disclosure claims the benefit of Chinese Patent Application Number 201510245800.4 filed May 14, 2015, entitled “ELECTRONIC MAIL PROCESSING METHOD, CLIENT TERMINAL, AND SERVER” which is hereby incorporated by reference in its entirety.

### TECHNICAL FIELD

The present disclosure relates to the field of computer communication, and, more particularly, to an electronic mail processing method, client terminal, and server.

### BACKGROUND

During a task process of an enterprise, a large amount of important information needs to be archived for further review. Especially for some orders or decisions of supervisors, written records are needed, for future reviewing or for circulating among employees of the enterprise. With respect to enterprises, at first, documents are printed on paper to be circulated or archived. However, as the enterprises develop, the number of such documents will increase, making the documents inconvenient to circulate. Nowadays, with the development of computer network technologies, most enterprises now use electronic mails for communication. Electronic mail is quite convenient and fast in communicating information, and brings great convenience for the communication inside and among enterprises.

However, as the communication inside enterprises via electronic mail becomes more frequent, employees of the enterprise will receive a large number of electronic mails every day. Part of the electronic mails may contain important instructions from supervisors, and most of the electronic mails may be communication about business among colleagues. Because these mails are mixed together, it is difficult to identify important mails from all of these mails. Especially when an employee comes back after a business trip, there will be a lot of electronic mails that have not been read, and the employee may not have enough time to read the mails one by one. However, some of those accumulated electronic mails may contain important instructions from supervisors, and as they are scattered in the email box, the employee cannot know the content timely. Therefore, electronic mail systems in the conventional techniques cannot meet the requirements of users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

An objective of example embodiments of the present disclosure is to provide an electronic mail processing method, client terminal, and server, which make it convenient to find and read important mails.

To solve the above technical problem, the present disclosure provides an electronic mail processing method, which includes: acquiring an electronic mail to obtain an identity identifier that identifies a mail sender; acquiring relationship data corresponding to the identity information of the identity identifier, wherein the relationship data represents a social relationship between mail communication participants; and when the social relationship represented by the relationship data satisfies a predetermined screening rule, presenting the electronic mail on the basis of a predetermined presentation rule.

The present disclosure further provides a client terminal, which includes: a mail acquisition module that acquires an electronic mail to obtain an identity identifier that identifies a mail sender; a relationship data acquisition module that acquires relationship data corresponding to the identity information of the identity identifier, wherein the relationship data represents a social relationship between mail communication participants; and a processing module that, when the social relationship represented by the relationship data satisfies a predetermined screening rule, presents the electronic mail on the basis of a predetermined presentation rule.

The present disclosure further provides an electronic mail processing method, which includes: receiving an electronic mail, and obtaining, according to the electronic mail, a first identity identifier that identifies a mail sender and a second identity identifier that identifies a mail recipient; acquiring relationship data that corresponds to the first identity identifier and the second identity identifier, wherein the relationship data represents a social relationship between the mail communication participants; when the social relationship represented by the relationship data satisfies a predetermined screening rule, setting a mark for the electronic mail on the basis of a predetermined marking rule; and sending the electronic mail with the mark to a client terminal of the mail recipient.

The present disclosure further provides a server, which includes: a mail receiving module that receives an electronic mail, and obtaining, according to the electronic mail, a first identity identifier that identifies a mail sender and a second identity identifier that identifies a mail recipient; a relationship data acquisition module that acquires relationship data that corresponds to the first identity identifier and the second identity identifier, wherein the relationship data represents a social relationship between the mail communication participants; a marking module that, when the social relationship represented by the relationship data satisfies a predetermined screening rule, sets a mark for the electronic mail on the basis of a predetermined marking rule; and a sending module that sends the electronic mail with the mark to a client terminal of the mail recipient.

As shown from the above technical solutions provided by the example embodiments of the present disclosure, an importance level of an electronic mail with respect to a mail recipient is determined according to a social relationship between a mail sender and the mail recipient, so that important mails and ordinary mails are presented in a distinguished manner, thereby allowing a user to find and read important mails more easily and directly, bringing convenience to the user.

### BRIEF DESCRIPTION OF THE DRAWINGS

To describe the technical solutions in the example embodiments of the present disclosure more clearly, the drawings that need to be used in the example embodiments are briefly introduced. It would be apparent that the drawings in the following description are merely some example embodiments of the present disclosure, and those of ordinary skill in the art may further obtain other drawings according to these drawings without creative efforts.

FIG. 1 is a flowchart of an example mail processing method according to an example embodiment of the present disclosure;

FIG. 2 is a flowchart of an example mail processing method according to an example embodiment of the present disclosure;

FIG. 3 is a flowchart of an example mail processing method according to an example embodiment of the present disclosure;

FIG. 4 is a block diagram of an example client terminal according to an example embodiment of the present disclosure;

FIG. 5 is a flowchart of an example mail processing method according to an example embodiment of the present disclosure;

FIG. 6 is a flowchart of an example mail processing method according to an example embodiment of the present disclosure;

FIG. 7 is a flowchart of an example mail processing method according to an example embodiment of the present disclosure;

FIG. 8 is a block diagram of an example server according to an example embodiment of the present disclosure.

### DETAILED DESCRIPTION

To enable those skilled in the art to better understand the technical solutions of the present disclosure, the technical solutions in the example embodiments of the present disclosure will be described below with reference to the accompanying drawings in the example embodiments of the present disclosure. It would be apparent that the described example embodiments are merely some and not all embodiments of the present disclosure. All other example embodiments obtained by those of ordinary skill in the art based on the example embodiments of the present disclosure without creative efforts shall fall within the protection scope of the present disclosure.

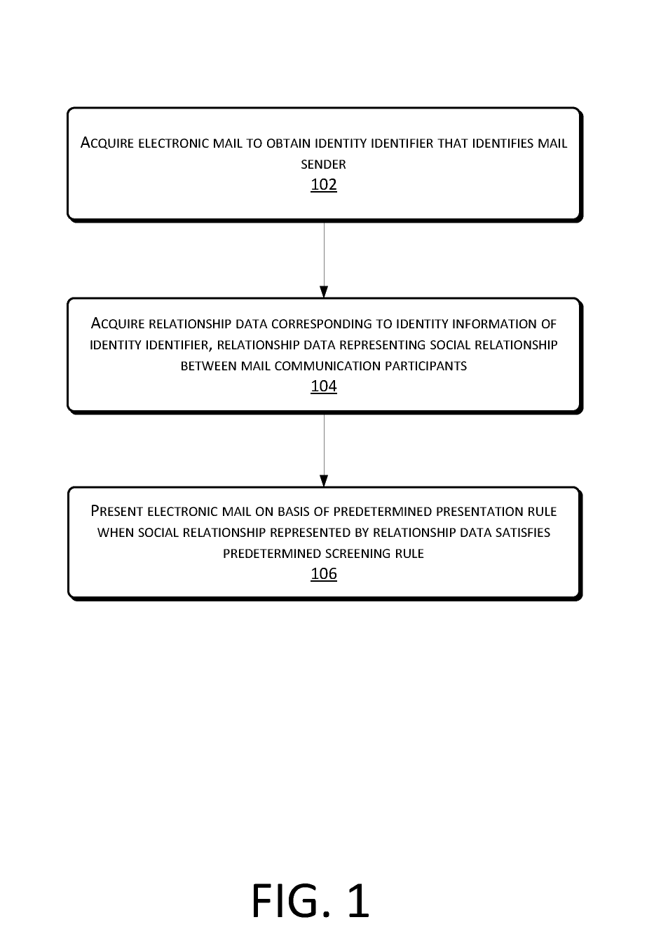

Referring to FIG. 1, a data interaction method is provided according to one example embodiment of the present disclosure, which includes the following steps:

At 102, an electronic mail is acquired to obtain an identity identifier that identifies a mail sender.

In this example embodiment, a mail sender may be a user that sends an electronic mail. An identity identifier is used to uniquely identify a user, and the user may be a mail sender or may be a mail recipient. Specifically, for example, the identity identifier may be a character string that is defined on the basis of a predetermined rule, such as an email box account, or a name self-defined by the user.

In this example embodiment, the identity identifier sent by the mail sender is acquired according to the electronic mail. A specific acquisition method may be: after the electronic mail is received, the identity identifier is read from the electronic mail; in this example embodiment, the identity identifier may be an email box account of the user. Alternatively, a method for acquiring the identity identifier may be: after the electronic mail is received, an email box account of the mail sender is acquired, and a stored database is searched, according to the email box account, for an identity identifier bound to the email box account of the mail sender.

At 104, relationship data corresponding to the identity information of identity identifier is acquired, wherein the relationship data represents a social relationship between mail communication participants.

In this example embodiment, the relationship data may represent a social relationship between mail communication participants. The mail communication participants include a mail recipient and a mail sender. The mail recipient may be the current user. In this example embodiment, the relationship data is from the first-person perspective of the current user, and therefore represents a social relationship between other users and the current user. For example, the relationship data may include a social relationship such as a hierarchical relationship in a company, a family relationship, a business relationship, or a friend relationship. The hierarchical relationship may include superior, subordinate, peer and so on; the business relationship may include, for example, ordinary customer, important customer, supplier and so on; the family relationship may include father, mother, elder brother, younger brother, wife, son, daughter and so on. Certainly, the relationship data is not limited to the above examples, and those skilled in the art may also make other modifications under the teaching of the technical essence of the present disclosure, and such modifications shall all fall within the protection scope of the present disclosure as long as the same or similar functions and effects as those in the present disclosure may be achieved. In this example embodiment, the expression form of the relationship data may be a character string, which is used to represent a social relationship.

In this example embodiment, a method for acquiring the relationship data may include searching the locally stored relationship data for the relationship data corresponding to the identity identifier of the mail sender; or may include downloading the relationship data from a predetermined server. For example, during search, the identity identifier of the mail recipient may be used as a query term to search the stored data.

In this example embodiment, a method for storing the identity identifier and the relationship data in a corresponding manner may use a data table. In the data table, for example, the first column of data records identity identifiers of target persons, the second column of data is used to represent relationship data, and the relationship data is from the first-person perspective of the current user. One row of data in the data table may form one data object, and the data object includes an identity identifier and relationship data that correspond to each other. The relationship data may be used to represent a social relationship between the mail sender and the mail recipient. For example, a data object includes: an identity identifier of a target person which is used to identify a user B, and relationship data being a superior. In this case, it is construed as that the user B is a superior of the current user. For example, when searching for the relationship data corresponding to the identity identifier, the identity identifier of the mail sender may be used to search the first column of data for an identity identifier that is the same as the identity identifier of the mailbox recipient, so that the corresponding relationship data is obtained. Certainly, other data structures may also be used to store the identity identifier and the relationship data in a corresponding manner. For example, the current user is considered as a data object, and the identity identifier and the relationship data are used as attributes of this data object. Certainly, those skilled in the art may also make other modifications, and such modifications shall all fall within the protection scope of the present disclosure as long as the same or similar functions and effects as those in the present disclosure may be achieved.

At 106, when the social relationship represented by the relationship data satisfies a predetermined screening rule, the electronic mail is presented on the basis of a predetermined presentation rule.

In this example embodiment, the predetermined screening rule is used to screen electronic mails, so that important electronic mails are presented according to the predetermined presentation rule, thereby allowing the user to find and read the important electronic mails more easily. In the predetermined screening rule, screening criteria may be set according to the social relationship represented by the relationship data, so that relationship data satisfying a given social relationship is considered to satisfy the predetermined screening rule, thereby distinguishing the importance levels of the electronic mails depending on the social relationship. Specifically, for example, the predetermined screening rule may include: when the relationship data indicates that the mail sender is a superior of the current user, it is considered that the predetermined screening rule is satisfied, that is, the relationship data is used to represent a superior. In this case, if the acquired relationship data is used to represent a superior, the electronic mail can be presented on the basis of the predetermined presentation rule.

In this example embodiment, presentation content of the electronic mails may be presented in the form of a list, so that the user may choose to open one of the electronic mails to read the detailed content. The presentation content may include one or more of a mail subject, a mail sender, a mail sending time, a mail receiving time, and a content digest. The predetermined presentation rule may include processing text, background and composition of the presentation content, so that presentation content of electronic mails that satisfy the predetermined screening rule will be presented in a manner different from that for common electronic mails. In this way, the presentation content of the electronic mails that satisfy the predetermined screening rule are prominent and are easily found and read by the user.

In this example embodiment of the present disclosure, mail senders of electronic mails are associated with social relationships, so that when a mail sender is at an important position in the social relationship, it is considered that an electronic mail sent by the mail sender is relatively important. By setting the predetermined screening rule, the important electronic mails may be identified by screening, and further the electronic mails may be presented on the basis of the predetermined presentation rule. In this way, important electronic mails and non-important electronic mails of the user may be distinguished, thereby making it convenient for the user to find and read the important electronic mails.

In an example embodiment, the operations at 102 include downloading all electronic mails of a current email box from a mail server to obtain an identity identifier of the mail sender of each of the electronic mails in the current email box.

In this example embodiment, electronic mails may be downloaded from a mail server to a local terminal, and identity identifiers of mail senders are obtained according to the electronic mails. The mail server may store electronic mails in the form of an email box, wherein each email box has an email box account, and the email box account may be used as an identity identifier. A password may be set for the email box, and after the email box account number and the password are provided to the mail server, the mail server grants permission for opening the corresponding email box, so that electronic mails are downloaded from the email box.

In this example embodiment, all electronic mails are downloaded from the email box, so that all the electronic mails may be screened, and important electronic mails among them may be presented on the basis of the predetermined presentation rule, thereby making it convenient for the user to find and read the important electronic mails.

In this example embodiment, the operations at 104 include acquiring relationship data corresponding to the identity identifier of the mail sender of each of the electronic mails. After the identity identifier of the mail sender of each of the electronic mails is obtained, the relationship data corresponding to each identity identifier is acquired, subsequently the relationship data is compared with the predetermined screening rule, and when the predetermined screening rule is satisfied, the electronic mail is further presented on the basis of the predetermined presentation rule.

In an example embodiment, the operations at 102 include reading locally stored electronic mails to obtain an identity identifier of the mail sender of each electronic mail of the stored electronic mails. The operations at 104 include acquiring relationship data corresponding to the identity identifier of the mail sender of each of the electronic mails.

In this example embodiment, the locally stored electronic mails may be screened to present important electronic mails on the basis of the predetermined presentation rule. The locally stored electronic mails that are read may be historical archives of electronic mails. In this case, the historical archives of the electronic mails are screened to present the screened important electronic mails on the basis of the predetermined presentation rule. In this way, the important electronic mails may be easily found from the historical archives for reviewing by the user, greatly facilitating work of the user.

In an example embodiment, the operations at 102 include acquiring an electronic mail that has not been read to obtain an identity identifier that identifies a mail sender. The operations at 104 include acquiring relationship data corresponding to the identity identifier of the mail sender of the electronic mail that has not been read.

In this example embodiment, an identity identifier of an electronic mail that has not been read is acquired, then relationship data corresponding to the identity identifier is acquired, and the relationship data is screened by determining whether the relationship data satisfies a predetermined screening rule, thereby screening the electronic mail identified by the identity identifier.

In this example embodiment, electronic mails that have not been read are acquired, and because the electronic mails that have not been read are mostly newly received electronic mails, screening these electronic mails that have not been read and presenting important electronic mails on the basis of the predetermined presentation rule effectively prompt the user that important electronic mails have been received, thereby allowing the user to learn important information in time.

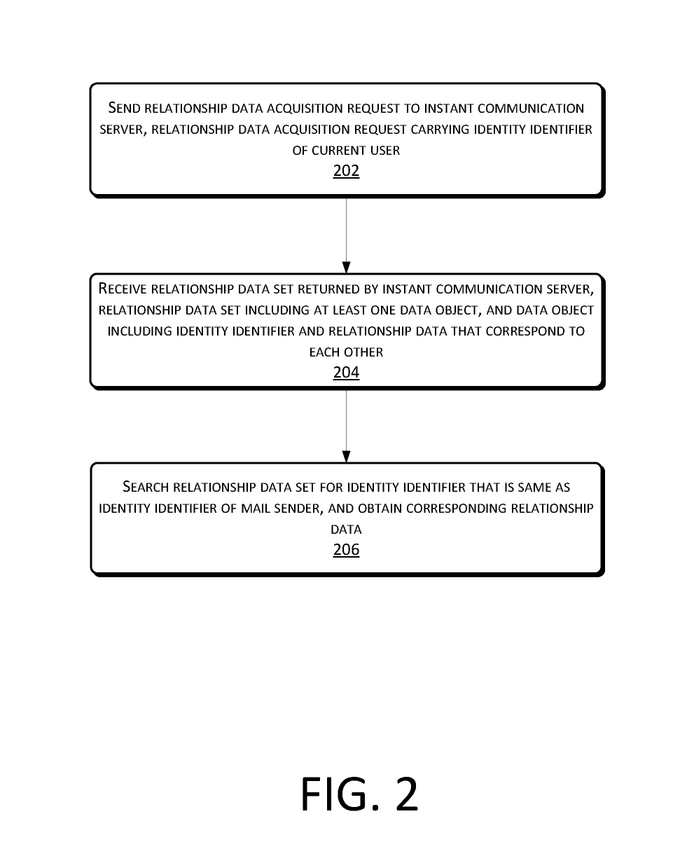

Referring to FIG. 2, in an example embodiment, the operations at 104 include the following operations:

At 202, a relationship data acquisition request is sent to an instant communication server, wherein the relationship data acquisition request carries an identity identifier of a current user.

In this example embodiment, relationship data may be stored in an instant communication server, and a relationship data acquisition request may be sent to the instant communication server to acquire relationship data.

In this example embodiment, the relationship data acquisition request carries the identity identifier of the current user to acquire relationship data corresponding to the identity identifier. The relationship data acquired according to the identity identifier of the current user is relationship data created from the first-person perspective of the current user. Therefore, the importance level of an electronic mail with respect to the current user is determined by determining the importance level of the electronic mail.

In this example embodiment, the relationship data acquisition request carries the identity identifier, which may be that the identity identifier serves as part of content of the relationship data acquisition request, or may be that the identity identifier serves as an attachment to the relationship data acquisition request. Specifically, for example, if the identity identifier is “123@taobao.com”, the content of the relationship data acquisition request may be “request 123@taobao.com”. Alternatively, the content of the relationship data acquisition request may be “request”, and “123@taobao.com” serves as an attachment.

At 204, a relationship data set returned by the instant communication server is received, wherein the relationship data set includes at least one data object, and the data object includes an identity identifier and relationship data that correspond to each other.

In this example embodiment, after receiving the relationship data acquisition request, the instant communication server searches locally stored data for relationship data corresponding to the second identity identifier, and uses the search result to form a relationship data set. Specifically, the instant communication server searches a data column that records identity identifiers from the first-person perspective in a locally stored data table for an identity identifier that is the same as the identity identifier of the current user, and uses the search result together with an identity identifier and relationship data of a corresponding target person to form a relationship data set. The data object may include one identity identifier from the first-person perspective, and an identity identifier and relationship data of one target person. It may also be construed as that data recorded in one row of the data table forms one data object.

At 206, the relationship data set is searched for an identity identifier that is the same as the identity identifier of the mail sender, and corresponding relationship data is obtained.

In this example embodiment, the relationship data set returned by the instant communication server may be construed as all data objects corresponding to the identity identifier of the current user that serves as the identity identifier from the first-person perspective. In this way, if the identity identifier of the mail sender is found in the relationship data set, a data object including the identity identifier of the mail sender is determined, and relationship data in the data object is obtained.

In this example embodiment, because the relationship data is uniformly stored in the instant communication server and the client terminal does not need to locally store and manage the relationship data, repeated data storage is avoided, thereby conserving the storage space of the client terminal.

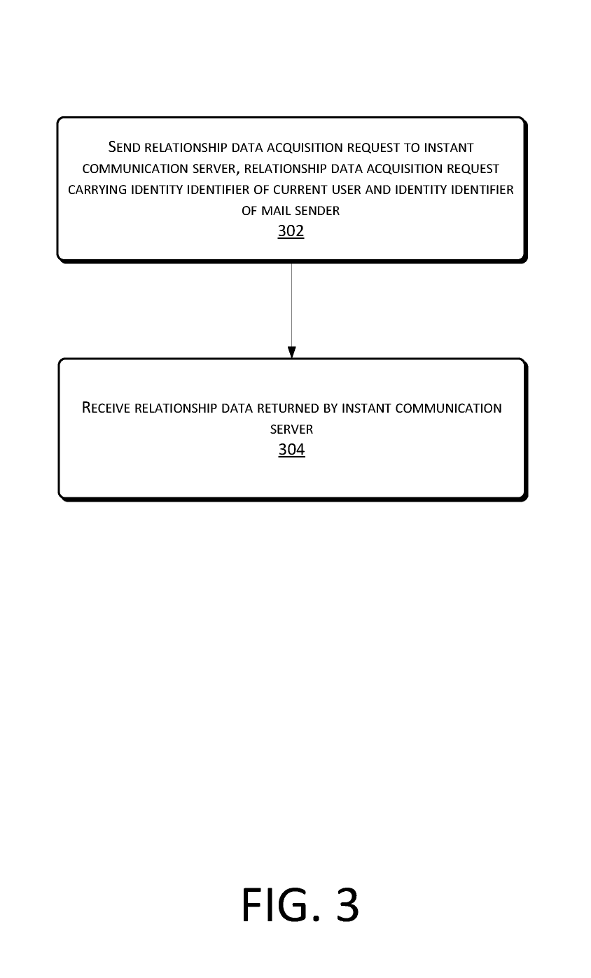

Referring to FIG. 3, in an example embodiment, the operations at 104 include the following steps:

At 302, a relationship data acquisition request is sent to the instant communication server, wherein the relationship data acquisition request carries an identity identifier of a current user and the identity identifier of the mail sender.

At 304, relationship data returned by the instant communication server is received.

In this example embodiment, the instant communication server stores relationship data, and a relationship data acquisition request is sent to the instant communication server to acquire required relationship data. The relationship data acquisition request carries the identity identifier of the current user and the identity identifier of the mail sender, so that the instant communication server accurately finds the relationship data. Specifically, for example, after receiving the relationship data acquisition request, the instant communication server searches a stored data table for data objects in which the identity identifier of the current user serves as an identity identifier from the first-person perspective, and further searches the data objects for a data object in which the identity identifier of the mail sender serves as an identity identifier of a target person, and then obtains corresponding relationship data. In this example embodiment, the acquiring of relationship data is implemented by receiving the relationship data sent by the instant communication server.

In an example embodiment, the operations at 104 include reading locally stored relationship data that corresponds to the identity identifier of the mail sender.

In this example embodiment, relationship data is locally stored, so that by searching locally for the identity identifier of the mail sender, corresponding relationship data is obtained. The locally stored relationship data may all be from the first-person perspective of the current user, so that by simply searching identity identifiers of target persons for the identity identifier of the mail sender, corresponding relationship data is obtained.

In an example embodiment, the predetermined screening rule in 106 includes: the acquired relationship data is the same as predetermined relationship data.

In this example embodiment, a plurality of pieces of predetermined relationship data may be set in advance, and when acquired relationship data is the same as the predetermined relationship data, it is considered that the predetermined screening rule is satisfied. The predetermined relationship data may be specific relationship data that is designated. Specifically, for example, the predetermined relationship data may include: senior leader, immediate superior and the like.

In this example embodiment, the relationship data is used to represent a social relationship or a family relationship, and the predetermined relationship data represents a superior leader or a senior family member. Therefore, it may be construed as that a mail sent from a superior leader or a senior family member is relatively important, and the user needs to be reminded to read the mail in time. Specifically, for example, superior leaders may include a senior leader and an immediate superior. Senior family members may include grandfather, grandmother, father, mother, uncle and the like.

In an example embodiment, relationship data is ranked according to a social relationship or family relationship represented by the relationship data, and the predetermined screening rule includes: acquired relationship data has a ranking higher than a predetermined ranking.

In this example embodiment, roles represented by the relationship data are ranked. Specifically, for example, in a company, a senior leader has a ranking of 3, an immediate superior has a ranking of 2, and a peer has a ranking of 1; for another example, father and mother have a ranking of 3, wife and son have a ranking of 2, and other relatives have a ranking of 1 or 0. The acquired relationship data also corresponds to a ranking, and by setting a predetermined ranking in advance, relationship data have a ranking higher than the predetermined ranking is considered to satisfy the predetermined screening rule.

In an example embodiment, the relationship data is used to represent an importance level, and the predetermined screening rule includes: the relationship data is larger than or equal to a predetermined importance level.

In this example embodiment, the relationship data is used to represent an importance level. The importance level is used to represent a relationship between the current user and the mail sender. Similarly, the importance level is from the first-person perspective of the current user. The higher the importance level is, the more important the mail sender is to the current user, and therefore the current user needs to process the mail in time. Specifically, for example, there are a user A, a user B and a current user C, wherein the current user C is an ordinary employee, the user A is a senior leader, and the user B is an immediate superior of the current user C. From the first-person perspective of the current user C, the user A may have an importance level of 3, the user B may have an importance level of 2, and the predetermined importance level may be 2. In this case, when the current user C receives an electronic mail from the user A or the user B, the electronic mail will be presented on the basis of the predetermined presentation rule, for the current user C to read.

In an example embodiment, the operations at 106 include classifying the electronic mail on the basis of the relationship data, wherein the classification is used as a basic unit for determining whether the predetermined screening rule is satisfied.

In this example embodiment, electronic mails are classified on the basis of the relationship data, so that when it is further determined whether the predetermined screening rule is satisfied, the determination step may be performed for all electronic mails under a same category at a time, and does not need to be performed once for the relationship data corresponding to each electronic mail, thereby reducing the amount of computation. Specifically, for example, the relationship data may include senior leader, middle-level leader, immediate superior, and peer colleague. Assuming that there are a total of 50 electronic mails, after the electronic mails are classified on the basis of the aforementioned several relationship data, the process of screening the relationship data may be completed by comparing the relationship data with the predetermined screening rule for only four times.

In an example embodiment, at 106, the predetermined presentation rule includes highlighting the electronic mail that satisfies the predetermined screening rule; or categorizing the electronic mail on the basis of relationship data, and presenting, on the basis of the category, the electronic mail that satisfies the predetermined screening rule.

In this example embodiment, a method for highlighting the electronic mail may include bolding the text in the presentation content of the electronic mail, changing the font of the text in the presentation content of the electronic mail, underlining the text in the presentation content of the electronic mail, changing the color of the text in the presentation content of the electronic mail, or the like. In this way, the electronic mails corresponding to the relationship data that satisfies the predetermined screening rule are displayed in a manner different from that for the electronic mails corresponding to the relationship data that does not satisfy the predetermined screening rule, so that the electronic mails corresponding to the relationship data that satisfies the predetermined screening rule are found more easily.

In this example embodiment, the electronic mails are categorized on the basis of the relationship data, and after it is determined whether the predetermined screening rule is satisfied, the electronic mails corresponding to the relationship data that satisfies the predetermined screening rule are presented on the basis of the categories, thereby not only making it convenient for the user to read the electronic mails according to the categories, but also making it convenient for the user to search the historical mails. Specifically, for example, the relationship data includes senior leader, middle-level leader, immediate superior, and peer colleague. In this case, the relationship data that satisfies the predetermined screening rule may include senior leader, middle-level leader and immediate superior. Therefore, during presentation, the electronic mails are categorized into three categories, namely, senior leader, middle-level leader and immediate superior. In this way, the user distinguishes the importance levels of the electronic mails during reading, and therefore may learn important information in time. In addition, the user may easily find and read instructions from leaders of various levels in the company.

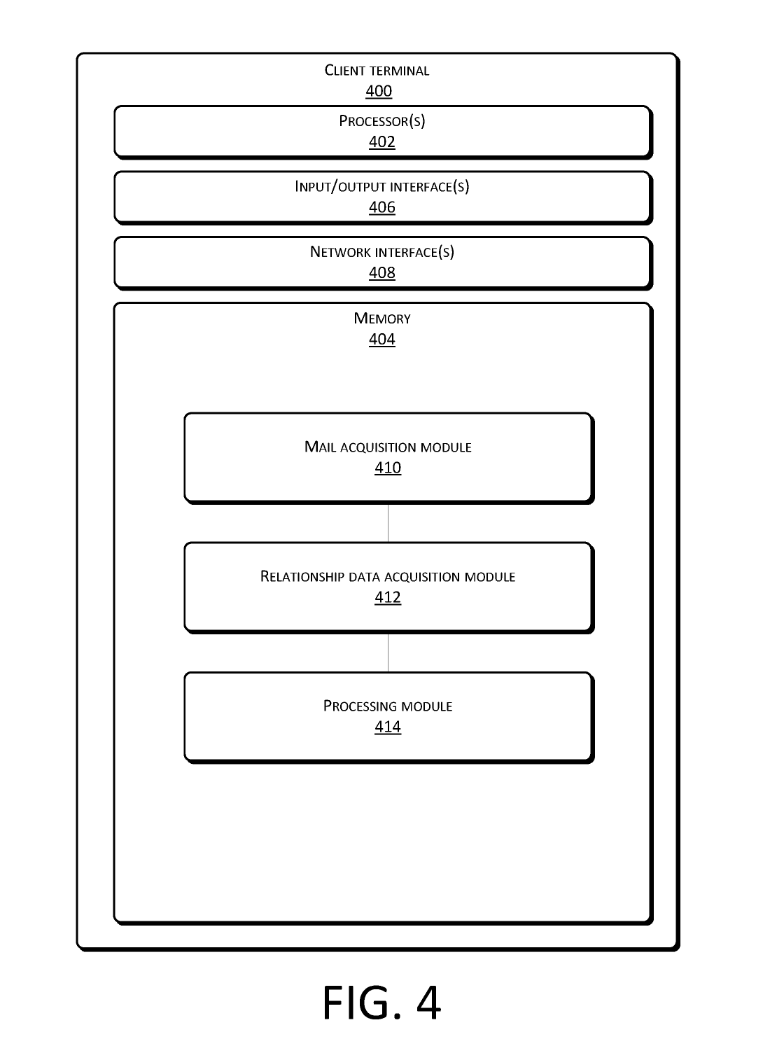

Referring to FIG. 4, an example embodiment of the present disclosure further provides a client terminal 400. The client terminal 400 includes one or more processor(s) 402 or data processing unit(s) and memory 404. The client terminal 400 may further include one or more input/output interface(s) 406, and network interface(s) 408. The memory 404 is an example of computer-readable media.

The computer-readable media includes volatile and non-volatile, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

The memory 404 may store therein a plurality of modules or units including a mail acquisition module 410, a relationship data acquisition module 412, and a processing module 414.

The mail acquisition module 410 acquires an electronic mail to obtain an identity identifier that identifies a mail sender.

In this example embodiment, a mail sender may be a user that sends an electronic mail. An identity identifier is used to uniquely identify a user, and the user may be a mail sender or may be a mail recipient. Specifically, the identity identifier may be a character string that is defined on the basis of a predetermined rule, for example, an email box account, or a name self-defined by the user.

In this example embodiment, the identity identifier sent by the mail sender is acquired according to the electronic mail. For example, a specific acquisition method may be: after the electronic mail is received, the identity identifier is read from the electronic mail; in this example embodiment, the identity identifier may be an email box account of the user. Alternatively, a method for acquiring the identity identifier may be: after the electronic mail is received, an email box account of the mail sender is acquired, and a stored database is searched, according to the email box account, for an identity identifier bound to the email box account of the mail sender. The mail acquisition module 410 may download the electronic mail from a mail server, or may read the stored electronic mail locally from the client terminal 400.

The relationship data acquisition module 412 acquires relationship data corresponding to the identity information, wherein the relationship data represents a social relationship between mail communication participants.

In this example embodiment, the relationship data may represent a social relationship between mail communication participants. The mail communication participants include a mail recipient and a mail sender. The mail recipient may be the current user. In this example embodiment, the relationship data is from the first-person perspective of the current user, and therefore represents a social relationship between other users and the current user. Specifically, the relationship data may include a social relationship such as a hierarchical relationship in a company, a family relationship, a business relationship, or a friend relationship. The hierarchical relationship may include superior, subordinate, peer and so on; the business relationship may include, for example, ordinary customer, important customer, supplier and so on; the family relationship may include father, mother, elder brother, younger brother, wife, son, daughter and so on. Certainly, the relationship data is not limited to the above examples, and those skilled in the art may also make other modifications under the teaching of the technical essence of the present disclosure, and such modifications shall all fall within the protection scope of the present disclosure as long as the same or similar functions and effects as those in the present disclosure may be achieved. In this example embodiment, the expression form of the relationship data may be a character string, which is used to represent a social relationship.

In this example embodiment, the relationship data acquisition module 412 may search the locally stored relationship data for the relationship data corresponding to the identity identifier of the mail sender; or may download the relationship data from a predetermined server. Specifically, during search, the identity identifier of the mail recipient may be used as a query term to search the stored data.

In this example embodiment, a method for storing the identity identifier and the relationship data in a corresponding manner may use a data table. For example, in the data table, the first column of data records identity identifiers of target persons, the second column of data is used to represent relationship data, and the relationship data is from the first-person perspective of the current user. One row of data in the data table may form one data object, and the data object includes an identity identifier and relationship data that correspond to each other. The relationship data may be used to represent a social relationship between the mail sender and the mail recipient. For example, a data object includes: an identity identifier of a target person which is used to identify a user B, and relationship data being a superior. In this case, it is construed that the user B is a superior of the current user. Specifically, when searching for the relationship data corresponding to the identity identifier, the identity identifier of the mail sender may be used to search the first column of data for an identity identifier that is the same as the identity identifier of the mailbox recipient, so that the corresponding relationship data is obtained. Certainly, other data structures may also be used to store the identity identifier and the relationship data in a corresponding manner. For example, the current user is considered as a data object, and the identity identifier and the relationship data are used as attributes of this data object. Certainly, those skilled in the art may also make other modifications, and such modifications shall all fall within the protection scope of the present disclosure as long as the same or similar functions and effects as those in the present disclosure can be achieved.

The processing module 414, when the social relationship represented by the relationship data satisfies a predetermined screening rule, presents the electronic mail on the basis of a predetermined presentation rule.

In this example embodiment, the predetermined screening rule is used to screen electronic mails, so that important electronic mails may be presented according to the predetermined presentation rule, thereby allowing the user to find and read the important electronic mails more easily. In the predetermined screening rule, screening criteria may be set according to the social relationship represented by the relationship data, so that relationship data satisfying a given social relationship is considered to satisfy the predetermined screening rule, thereby distinguishing the importance levels of the electronic mails depending on the social relationship. Specifically, for example, the predetermined screening rule may include: when the relationship data indicates that the mail sender is a superior of the current user, it is considered that the predetermined screening rule is satisfied, that is, the relationship data is used to represent a superior. In this case, if the acquired relationship data is used to represent a superior, the electronic mail is presented on the basis of the predetermined presentation rule.

In this example embodiment, presentation content of the electronic mails may be presented in the form of a list, so that the user can choose to open one of the electronic mails to read the detailed content. The presentation content may include one or more of a mail subject, a mail sender, a mail sending time, a mail receiving time, and a content digest. The predetermined presentation rule may include processing text, background and composition of the presentation content, so that presentation content of electronic mails that satisfy the predetermined screening rule will be presented in a manner different from that for common electronic mails. In this way, the presentation content of the electronic mails that satisfy the predetermined screening rule are prominent and are easily found and read by the user.

In this example embodiment of the present disclosure, mail senders of electronic mails are associated with social relationships, so that when a mail sender is at an important position in the social relationship, it is considered that an electronic mail sent by the mail sender is relatively important. By setting the predetermined screening rule, the important electronic mails are identified by screening, and further the electronic mails are presented on the basis of the predetermined presentation rule. In this way, important electronic mails and non-important electronic mails of the user are distinguished, thereby making it convenient for the user to find and read the important electronic mails.

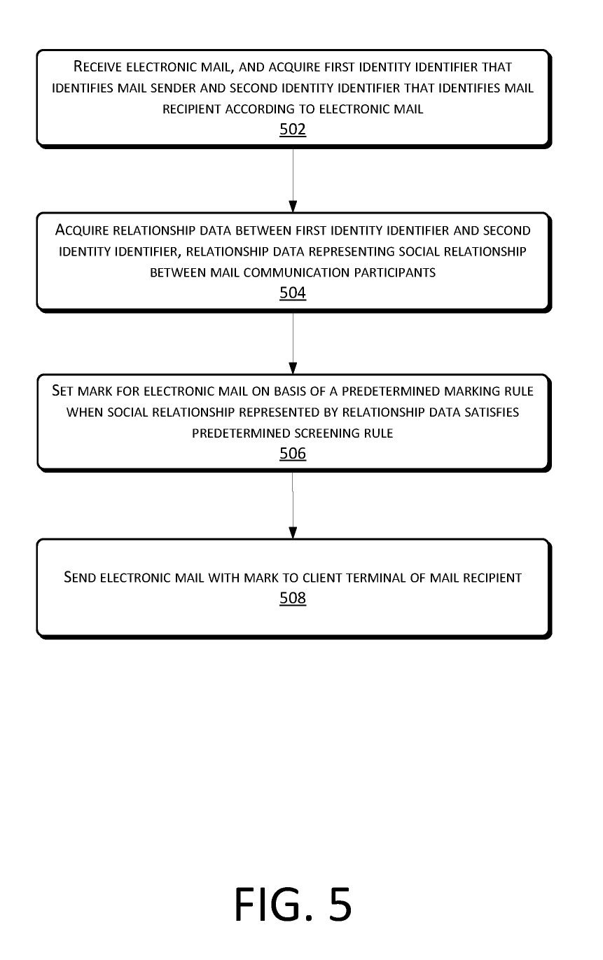

Referring to FIG. 5, one example embodiment of the present disclosure further provides an electronic mail processing method; the method includes the following operations:

At 502, an electronic mail is received, and according to the electronic mail, a first identity identifier that identifies a mail sender and a second identity identifier that identifies a mail recipient are acquired.

In this example embodiment, a mail sender may be a user that sends an electronic mail. A mail recipient may be a user that receives an electronic mail. An identity identifier is used to uniquely identify a user, and the user may be a mail sender or may be a mail recipient. Specifically, for example, the identity identifier may be a character string that is defined on the basis of a predetermined rule, such as an email box account, or a name self-defined by the user.

In this example embodiment, the first identity identifier and the second identity identifier are acquired according to the electronic mail sent by the mail sender. A specific acquisition method may be: after the electronic mail is received, the first identity identifier and the second identity identifier are read from the electronic mail; in this example embodiment, the first identity identifier and the second identity identifier may be email box accounts of users. Alternatively, a method for acquiring the first identity identifier and the second identity identifier may be: after the electronic mail is received, an email box account of the mail sender and an email box account of the mail recipient are acquired, and a stored database is searched, according to the email box accounts, for the first identity identifier bound to the email box account of the mail sender and the second identity identifier bound to the email box account of the mail recipient.

At 504, relationship data between the first identity identifier and the second identity identifier is acquired, wherein the relationship data represents a social relationship between the mail communication participants.

In this example embodiment, the relationship data may represent a social relationship between mail communication participants. The mail communication participants include a mail recipient and a mail sender. Specifically, for example, the relationship data may include a social relationship such as a hierarchical relationship in a company, a family relationship, a business relationship, or a friend relationship. The hierarchical relationship may include superior, subordinate, peer and so on; the business relationship may include, for example, ordinary customer, important customer, supplier and so on; the family relationship may include father, mother, elder brother, younger brother, wife, son, daughter and so on. Certainly, the relationship data is not limited to the above examples, and those skilled in the art may also make other modifications under the teaching of the technical essence of the present disclosure, and such modifications shall all fall within the protection scope of the present disclosure as long as the same or similar functions and effects as those in the present disclosure can be achieved. In this example embodiment, the expression form of the relationship data per se may be a character string, which is used to represent a social role.

In this example embodiment, a method for storing the first identity identifier, the second identity identifier and the relationship data in a corresponding manner may use a data table. For example, in the data table, the first column of data records identity identifiers from the first-person perspective, the second column of data records identity identifiers of target persons, and the third column of data is used to represent the relationship data. One row of data in the data table may form one data object, and the data object includes an identity identifier from the first-person perspective, an identity identifier of a target person, and relationship data that correspond to each other. The relationship data may be used to represent a relationship between users that are identified by the identity identifier from the first-person perspective and the identity identifier of the target person. For example, a data object includes: an identity identifier from the first-person perspective which is used to identify a user A, an identity identifier of a target person which is used to identify a user B, and relationship data being superior. In this case, it is construed that the user B is a superior of the user A. For another example, the identity identifier from the first-person perspective represents the user B, the identity identifier of the target person represents the user A, and the relationship data is subordinate. In this case, it is construed that the user A is a subordinate of the user B. Therefore, both the first identity identifier and the second identity identifier may be used as an identity identifier from the first-person perspective or an identity identifier of a target person, and the difference lies in that when used as an identity identifier from the first-person perspective respectively, the first identity identifier and the second identity identifier may correspond to different relationship data. Certainly, other data structures may also be used to store the identity identifier and the relationship data in a corresponding manner. For example, the current user is considered as a data object, and the identity identifier and the relationship data are used as attributes of this data object. Certainly, those skilled in the art may also make other modifications which shall all fall within the protection scope of the present disclosure as long as the same or similar functions and effects as those in the present disclosure may be achieved.

In this example embodiment, a method for acquiring the relationship data may include searching the locally stored relationship data for the relationship data that corresponds to the first identity identifier and the second identity identifier; or may include downloading the relationship data from a predetermined server. Specifically, during search, the data column that records identity identifiers from the first-person perspective may be searched for the second identity identifier that identifies the mail recipient to find the relationship data that is from the first-person perspective of the mail recipient.

At 506, when the social relationship represented by the relationship data satisfies a predetermined screening rule, a mark is set for the electronic mail on the basis of a predetermined marking rule.

At 508, the electronic mail with the mark is sent to a client terminal of the mail recipient.

In this example embodiment, the predetermined screening rule is used to screen electronic mails, so that important electronic mails are presented according to the predetermined presentation rule, thereby allowing the user to find and read the important electronic mails more easily. In the predetermined screening rule, screening criteria may be set according to the social relationship represented by the relationship data, so that relationship data satisfying a given social relationship is considered to satisfy the predetermined screening rule, thereby distinguishing the importance levels of the electronic mails depending on the social relationship. Specifically, for example, the predetermined screening rule may include: when the relationship data indicates that the mail sender is a superior of the current user, it is considered that the predetermined screening rule is satisfied, that is, the relationship data is used to represent a superior. In this case, if the acquired relationship data is used to represent a superior, the electronic mail is presented on the basis of the predetermined presentation rule.

In this example embodiment, the predetermined marking rule may be setting a mark for an electronic mail that satisfies the predetermined screening rule, so that after the electronic mail is sent to the client terminal, the client terminal may present the electronic mail to the user according to the mark and on the basis of the predetermined presentation rule. In this example embodiment, it is construed that an electronic mail that satisfies the predetermined screening rule and has a mark is a relatively important electronic mail with respect to the mail recipient. By setting a mark for electronic mails, the client terminal presents marked electronic mails and unmarked electronic mails in a distinguished manner, so that the user may directly see that there are important mails to be read, or the user may find target mails from historical archives more quickly.

In this example embodiment, a method for setting a mark for an electronic mail may include adding a mark field to an attribute part of the electronic mail, and correspondingly setting data for identifying that the electronic mail is marked; adding, to the content of the electronic mail, a character string for identifying that the electronic mail is marked; or adding, to an attachment part of the electronic mail, data for representing that the electronic mail is marked. Certainly, under the teaching of the technical essence of the present disclosure, other methods for setting a mark for an electronic mail may also be used, and shall all fall within the protection scope of the present disclosure as long as the same or similar functions and effects as those in the present disclosure may be achieved.

In this example embodiment, the electronic mail may be sent to the client terminal by using a mail service protocol. The client terminal may be a smart phone, a desktop computer, a notebook computer, a tablet computer, a smart wearable device or the like. Alternatively, the client terminal may be software that runs in the aforementioned hardware, and the software is capable of managing electronic mails.

In this example embodiment of the present disclosure, a social relationship between a mail sender and a mail recipient is determined, so that when the mail sender is at an important position in the social relationship, it is considered that an electronic mail sent by the mail sender is relatively important. By setting the predetermined screening rule, the important electronic mails can be identified by screening, and further a mark may be set for the electronic mails, so that a client terminal that receives the electronic mails can highlight the marked electronic mails. In this way, the user can easily find and read important electronic mails.

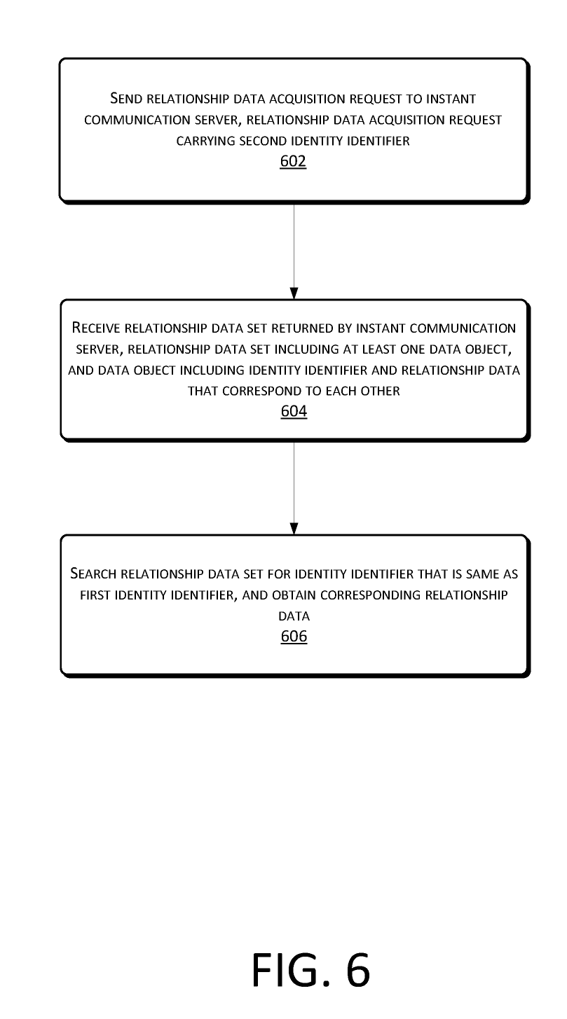

Referring to FIG. 6, in an example embodiment, the operations at 504 include the following operations:

At 602, a relationship data acquisition request is sent to an instant communication server, wherein the relationship data acquisition request carries the second identity identifier.

In this example embodiment, relationship data may be stored in an instant communication server, and after a mail is received, a relationship data acquisition request may be sent to the instant communication server to acquire relationship data.

In this example embodiment, the relationship data acquisition request carries the second identity identifier to acquire relationship data corresponding to the second identity identifier. The second identity identifier is used to identify the user of the mail recipient, so that the acquired relationship data is relationship data created from the first-person perspective of the mail recipient.

In this example embodiment, the relationship data acquisition request carries the second identity identifier, which serves as part of content of the relationship data acquisition request, or an attachment to the relationship data acquisition request. Specifically, for example, if the second identity identifier is “123@taobao.com”, the content of the relationship data acquisition request may be “request 123@taobao.com”. Alternatively, the content of the relationship data acquisition request may be “request”, and “123@taobao.com” serves as an attachment.

At 604, a relationship data set returned by the instant communication server is received, wherein the relationship data set includes at least one data object, and the data object includes an identity identifier and relationship data that correspond to each other.

In this example embodiment, after receiving the relationship data acquisition request, the instant communication server searches the locally stored data for relationship data corresponding to the second identity identifier, and uses the search result to form a relationship data set. Specifically, for example, the instant communication server searches a data column that records identity identifiers from the first-person perspective in a locally stored data table for an identity identifier that is the same as the second identity identifier, and uses the search result together with an identity identifier and relationship data of a corresponding target person to form a relationship data set. The data object may include an identity identifier from the first-person perspective, and an identity identifier and relationship data of a target person. It may also be construed that data recorded in one row of the data table forms one data object.

At 606, the relationship data set is searched for an identity identifier that is the same as the first identity identifier, and corresponding relationship data is obtained.

In this example embodiment, the relationship data set returned by the instant communication server may be construed as all data objects corresponding to the second identity identifier that serves as the identity identifier from the first-person perspective. In this way, if the first identity identifier is found in the relationship data set, a data object including the first identity identifier is determined, and relationship data in the data object is obtained.

In this example embodiment, because the relationship data is uniformly stored in the instant communication server and a mail server does not need to store and manage the relationship data, repeated data storage is avoided, thereby conserving the storage space and reducing data management costs.

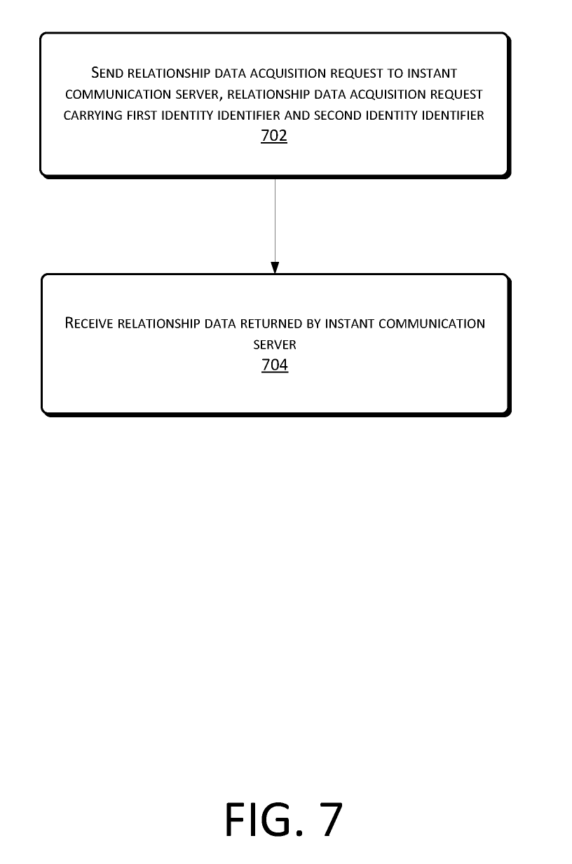

Referring to FIG. 7, in an example embodiment, the operations at 504 include the following operations:

At 702, a relationship data acquisition request is sent to the instant communication server, wherein the relationship data acquisition request carries the first identity identifier and the second identity identifier.

At 704, relationship data returned by the instant communication server is received.

In this example embodiment, the instant communication server stores the relationship data, and a relationship data acquisition request is sent to the instant communication server to acquire required relationship data. The relationship data acquisition request carries the first identity identifier and the second identity identifier, so that the instant communication server may accurately find the relationship data. Specifically, for example, after receiving the relationship data acquisition request, the instant communication server searches a stored data table for data objects in which the second identity identifier serves as an identity identifier from the first-person perspective, and further searches the data objects for a data object in which the first identity identifier serves as an identity identifier of a target person, and then obtains corresponding relationship data. In this example embodiment, the acquiring of relationship data is implemented by receiving the relationship data sent by the instant communication server.

In an example embodiment, the operations at 504 include reading locally stored relationship data that corresponds to the first identity identifier and the second identity identifier.

In this example embodiment, relationship data is locally stored, so that by searching locally for the first identity identifier and the second identity identifier, corresponding relationship data is obtained. Specifically, for example, a stored data table is searched for data objects in which the second identity identifier serves as an identity identifier from the first-person perspective, and further the data objects are searched for a data object in which the first identity identifier serves as an identity identifier of a target person, and then corresponding relationship data is obtained.

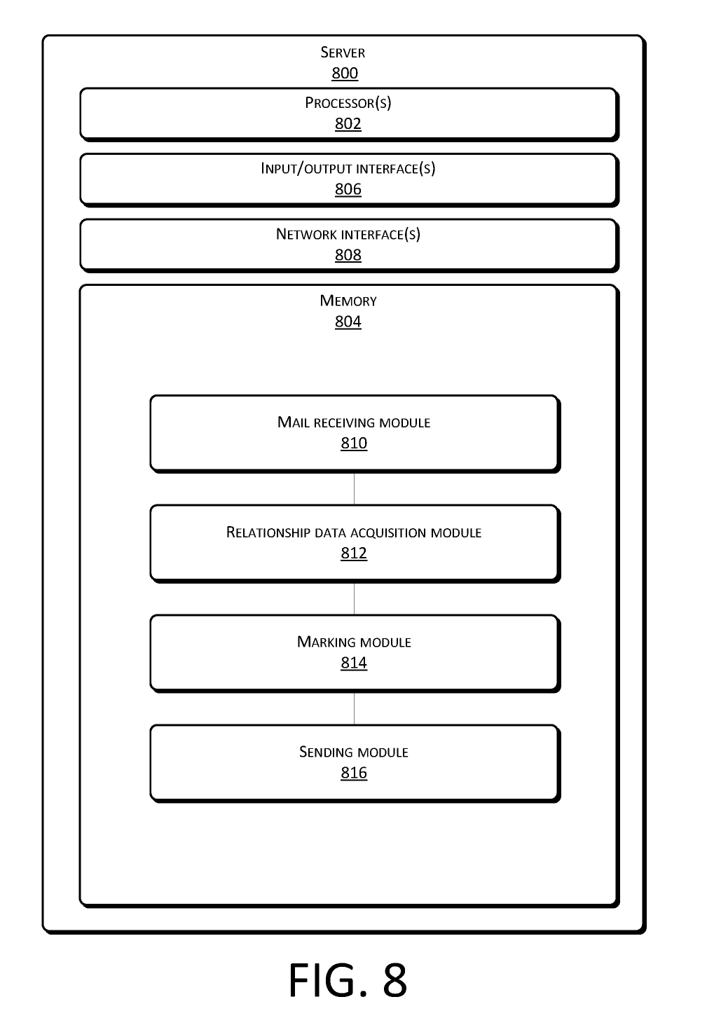

Referring to FIG. 8, an example embodiment of the present disclosure further provides a server 800. The server 800 includes one or more processor(s) 802 or data processing unit(s) and memory 804. The server 800 may further include one or more input/output interface(s) 806, and network interface(s) 808. The memory 804 is an example of computer-readable media.

The memory 804 may store therein a plurality of modules or units including a mail receiving module 810, a relationship data acquisition module 812, a marking module 814, and a sending module 816.

The mail receiving module 810 receives an electronic mail, and obtains, according to the electronic mail, a first identity identifier that identifies a mail sender and a second identity identifier that identifies a mail recipient.

In this example embodiment, a mail sender may be a user that sends an electronic mail. A mail recipient may be a user that receives an electronic mail. An identity identifier is used to uniquely identify a user, and the user may be a mail sender or may be a mail recipient. Specifically, for example, the identity identifier may be a character string that is defined on the basis of a predetermined rule such as an email box account, or a name self-defined by the user.

In this example embodiment, the first identity identifier and the second identity identifier are acquired according to the electronic mail sent by the mail sender. A specific acquisition method may be: after the electronic mail is received, the first identity identifier and the second identity identifier are read from the electronic mail; in this example embodiment, the first identity identifier and the second identity identifier may be email box accounts of users. Alternatively, a method for acquiring the first identity identifier and the second identity identifier may be: after the electronic mail is received, an email box account of the mail sender and an email box account of the mail recipient are acquired, and a stored database is searched, according to the email box accounts, for the first identity identifier bound to the email box account of the mail sender and the second identity identifier bound to the email box account of the mail recipient.

The relationship data acquisition module 812 acquires relationship data that corresponds to the first identity identifier and the second identity identifier, wherein the relationship data represents a social relationship between the mail communication participants.

In this example embodiment, the relationship data may represent a social relationship between mail communication participants. The mail communication participants include a mail recipient and a mail sender. Specifically, for example, the relationship data may include a social relationship such as a hierarchical relationship in a company, a family relationship, a business relationship, or a friend relationship. The hierarchical relationship may include superior, subordinate, peer and so on; the business relationship may include, for example, ordinary customer, important customer, supplier and so on; the family relationship may include father, mother, elder brother, younger brother, wife, son, daughter and so on. Certainly, the relationship data is not limited to the above examples, and those skilled in the art may also make other modifications under the teaching of the technical essence of the present disclosure, and such modifications shall all fall within the protection scope of the present disclosure as long as the same or similar functions and effects as those in the present disclosure may be achieved. In this example embodiment, the expression form of the relationship data may be a character string, which is used to represent a social role.

In this example embodiment, a method for storing the first identity identifier, the second identity identifier and the relationship data in a corresponding manner may use a data table. For example, in the data table, the first column of data records identity identifiers from the first-person perspective, the second column of data records identity identifiers of target persons, and the third column of data is used to represent the relationship data. One row of data in the data table may form one data object, and the data object includes an identity identifier from the first-person perspective, an identity identifier of a target person, and relationship data that correspond to each other. The relationship data may be used to represent a relationship between users that are identified by the identity identifier from the first-person perspective and the identity identifier of the target person. For example, a data object includes: an identity identifier from the first-person perspective which is used to identify a user A, an identity identifier of a target person which is used to identify a user B, and relationship data being superior. In this case, it is construed that the user B is a superior of the user A. For another example, the identity identifier from the first-person perspective represents the user B, the identity identifier of the target person represents the user A, and the relationship data is subordinate. In this case, it is construed that the user A is a subordinate of the user B. Therefore, both the first identity identifier and the second identity identifier may be used as an identity identifier from the first-person perspective or an identity identifier of a target person respectively, and the difference lies in that when used as an identity identifier from the first-person perspective, the first identity identifier and the second identity identifier may correspond to different relationship data. Certainly, other data structures may also be used to store the identity identifier and the relationship data in a corresponding manner. For example, the current user is considered as a data object, and the identity identifier and the relationship data are used as attributes of this data object. Certainly, those skilled in the art may also make other modifications which shall all fall within the protection scope of the present disclosure as long as the same or similar functions and effects as those in the present disclosure can be achieved.

In this example embodiment, a method for acquiring the relationship data may include searching the locally stored relationship data for the relationship data that corresponds to the first identity identifier and the second identity identifier; or may include downloading the relationship data from a predetermined server. Specifically, for example, during search, the data column that records identity identifiers from the first-person perspective may be searched for the second identity identifier that identifies the mail recipient to find the relationship data that is from the first-person perspective of the mail recipient.

The marking module 814, when the social relationship represented by the relationship data satisfies a predetermined screening rule, sets a mark for the electronic mail on the basis of a predetermined marking rule.

In this example embodiment, the predetermined screening rule is used to screen electronic mails, so that important electronic mails may be presented according to the predetermined presentation rule, thereby allowing the user to find and read the important electronic mails more easily. In the predetermined screening rule, screening criteria may be set according to the social relationship represented by the relationship data, so that relationship data satisfying a given social relationship is considered to satisfy the predetermined screening rule, thereby distinguishing the importance levels of the electronic mails depending on the social relationship. Specifically, for example, the predetermined screening rule may include: when the relationship data indicates that the mail sender is a superior of the current user, it is considered that the predetermined screening rule is satisfied, that is, the relationship data is used to represent a superior. In this case, if the acquired relationship data is used to represent a superior, the electronic mail can be presented on the basis of the predetermined presentation rule.

In this example embodiment, the predetermined marking rule may be setting a mark for an electronic mail that satisfies the predetermined screening rule, so that after the electronic mail is sent to the client terminal, the client terminal may present the electronic mail to the user according to the mark and on the basis of the predetermined presentation rule. In this example embodiment, it may be construed that an electronic mail that satisfies the predetermined screening rule and has a mark is a relatively important electronic mail with respect to the mail recipient. By setting a mark for electronic mails, the client terminal may present marked electronic mails and unmarked electronic mails in a distinguished manner, so that the user may directly see that there are important mails to be read, or the user may find target mails from historical archives more quickly.

In this example embodiment, a method for setting a mark for an electronic mail may include adding a mark field to an attribute part of the electronic mail, and correspondingly setting data for identifying that the electronic mail is marked; adding, to the content of the electronic mail, a character string for identifying that the electronic mail is marked; or adding, to an attachment part of the electronic mail, data for representing that the electronic mail is marked. Certainly, under the teaching of the technical essence of the present disclosure, other methods for setting a mark for an electronic mail may also be used, and shall all fall within the protection scope of the present disclosure as long as the same or similar functions and effects as those in the present disclosure may be achieved.

The sending module 216 sends the electronic mail with the mark to a client terminal of the mail recipient.

In this example embodiment, the electronic mail may be sent to the client terminal by using a mail service protocol. The client terminal may be a smart phone, a desktop computer, a notebook computer, a tablet computer, a smart wearable device or the like. Alternatively, the client terminal may be software that runs in the aforementioned hardware, and the software is capable of managing electronic mails.

In this example embodiment of the present disclosure, a social relationship between a mail sender and a mail recipient is determined, so that when the mail sender is at an important position in the social relationship, it is considered that an electronic mail sent by the mail sender is relatively important. By setting the predetermined screening rule, the important electronic mails are identified by screening, and further a mark may be set for the electronic mails, so that a client terminal that receives the electronic mails can highlight the marked electronic mails. In this way, the user may easily find and read important electronic mails.

As shown from the above technical solutions provided by the example embodiments of the present disclosure, an importance level of an electronic mail with respect to a mail recipient is determined according to a social relationship between a mail sender and the mail recipient, so that important mails and ordinary mails may be presented in a distinguished manner, thereby allowing a user to read important mails more easily and directly, bringing convenience to the user.

Multiple example embodiments of the present disclosure has been described in the present disclosure, and it should be understood by those skilled in the art that the example embodiments of the present disclosure may be combined with one another. In addition, those skilled in the art shall know that various modifications and variations may be made to the present disclosure without departing from the spirit of the present disclosure, and it is intended that the appended claims encompass these modifications and variations without departing from the spirit of the present disclosure.

What is claimed is:

1. A method comprising:
acquiring an electronic mail to obtain an identity identifier that identifies a mail sender, wherein the electronic mail is transmitted from the mail sender to a mail recipient;
acquiring relationship data corresponding to the identity identifier, the relationship data representing a connection relationship between the mail sender and the mail recipient; and
presenting, at a client terminal associated with the mail recipient, the electronic mail based on a predetermined presentation rule when the connection relationship represented by the relationship data satisfies a predetermined screening rule.

2. The method of claim 1, wherein the acquiring the electronic mail includes downloading one or more electronic mails of a current email box from a mail server to obtain a respective identity identifier of a respective mail sender of the one or more electronic mails in the current email box.

3. The method of claim 2, wherein the acquiring the relationship data includes acquiring relationship data corresponding to the respective identity identifier of the respective mail sender of the one or more electronic mails.

4. The method of claim 1, wherein:
the acquiring the electronic mail includes reading locally stored electronic mails to obtain a respective identity identifier of a respective mail sender of a respective mail of the stored electronic mails; and
the acquiring the relationship data includes acquiring relationship data corresponding to the respective identity identifier of the respective mail sender.

5. The method of claim 1, wherein:
the acquiring the electronic mail includes acquiring an electronic mail that has not been read to obtain the identity identifier that identifies the mail sender; and
the acquiring relationship data includes acquiring relationship data corresponding to the identity identifier of the mail sender of the electronic mail that has not been read.

6. The method of claim 1, wherein the acquiring the relationship data includes:
sending a relationship data acquisition request to an instant communication server, the relationship data acquisition request carrying an identity identifier of a current user;
receiving a relationship data set returned by the instant communication server, the relationship data set including at least a data object, and the data object including an identity identifier and relationship data that correspond to each other; and
searching the relationship data set for an identity identifier that is same as the identity identifier of the mail sender to obtain corresponding relationship data.

7. The method of claim 1, wherein the acquiring the relationship data includes:
sending a relationship data acquisition request to an instant communication server, the relationship data acquisition request carrying an identity identifier of a current user and the identity identifier of the mail sender; and
receiving the relationship data returned by the instant communication server.

8. The method of claim 1, wherein the acquiring the relationship data includes reading locally stored relationship data that corresponds to the identity identifier of the mail sender.

9. The method of claim 1, wherein the predetermined screening rule includes that the relationship data is same as predetermined relationship data.

10. The method of claim 9, wherein:
the relationship data represents a social relationship and the predetermined relationship data represents a superior leader; or
the relationship data represents a family relationship and the predetermined relationship data represents a senior family member.

11. The method of claim 1, wherein:
the relationship data is ranked according to a social relationship or family relationship represented by the relationship data; and
the predetermined screening rule includes that the relationship data has a ranking higher than a predetermined ranking.

12. The method of claim 1, wherein:
the relationship data represents an importance level; and
the predetermined screening rule includes that the relationship data is larger than or equal to a predetermined importance level.

13. The method of claim 1, wherein the presenting the electronic mail based on the predetermined presentation rule includes:
classifying the electronic mail based on the relationship data; and
using a result of the classifying to determine whether the predetermined screening rule is satisfied.

14. The method of claim 1, wherein the predetermined presentation rule includes:
highlighting the electronic mail that satisfies the predetermined screening rule; or
categorizing the electronic mail on the basis of relationship data, and presenting the electronic mail, based on one or more categories, that satisfies the predetermined screening rule.

15. A client terminal comprising:
a mail acquisition module that acquires an electronic mail to obtain an identity identifier that identifies a mail sender, wherein the electronic mail is transmitted from a mail sender to a mail recipient;
a relationship data acquisition module that acquires relationship data corresponding to the identity identifier, the relationship data representing a social relationship between the mail sender and the mail recipient; and
a processing module that, when the social relationship represented by the relationship data satisfies a predetermined screening rule, presents the electronic mail, at a client terminal associated with the mail recipient, based on a predetermined presentation rule.

16. A method comprising:
receiving an electronic mail;
obtaining, according to the electronic mail, a first identity identifier that identifies a mail sender and a second identity identifier that identifies a mail recipient;
acquiring relationship data that corresponds to the first identity identifier and the second identity identifier, the relationship data representing a social relationship between the mail communication participants;
setting a mark for the electronic mail based on a predetermined marking rule when the social relationship represented by the relationship data satisfies a predetermined screening rule; and
sending the electronic mail with the mark to a client terminal of the mail recipient.

17. The method of claim 16, wherein the acquiring the relationship data includes:
sending a relationship data acquisition request to an instant communication server, the relationship data acquisition request carrying the second identity identifier;
receiving a relationship data set returned by the instant communication server, the relationship data set including at least a data object, and the data object including an identity identifier and relationship data that correspond to each other; and
searching the relationship data set for an identity identifier that is same as the first identity identifier to obtain corresponding relationship data.

18. The method of claim 16, wherein the acquiring the relationship data includes:
sending a relationship data acquisition request to an instant communication server, the relationship data acquisition request carrying the first identity identifier and the second identity identifier; and
receiving the relationship data returned by the instant communication server.

19. The method of claim 16, wherein the acquiring the relationship data includes reading locally stored relationship data that corresponds to the first identity identifier and the second identity identifier.

20. The method of claim 16, wherein the relationship data represents an importance level.
